(19) United States
(12) Patent Application Publication
(10) Pub. No.: US 2007/0196060 A1
(43) Pub. Date: Aug. 23, 2007

(54) Method To Minimize Excess Cable Length

(76) Inventors: Hans Mickelsson, Sollentuna (SE); Torbjorn Cagenius, Sollentuna (SE)

Correspondence Address: ERICSSON INC., 6300 LEGACY DRIVE, M/S EVR 1-C-11, PLANO, TX, 75024, US

(21) Appl. No.: 10/595,138

(22) PCT Filed: Aug. 13, 2004
(86) PCT No.: PCT/SE04/01192

§ 371 Date: Nov. 10, 2006

(30) Foreign Application Priority Data
Sep. 5, 2003 (SE) 0302397-5

(51) Int. Cl. G02B 6/44

(52) U.S. Cl. 385/114; 385/135

(57) ABSTRACT

The present invention relates to method and arrangement to minimize excess fiber cable in large-scale point-to-point fiber installations, between equipment ODF, AE located in different equipment cabinets 1, 2. Each cabinet comprises at least one casing 4, 5, which casings are arranged to connect fiber cables with equipment in the cabinets via fan-out fiber cables 6, 7. The method comprises the following steps: Attaching one end of a ribbon fiber cable 3 to a casing 4 that is adherent to a first equipment cabinet 1. Routing of the ribbon fiber cable with a minimum excess length to a casing 5 adherent to a second equipment cabinet 2. Cutting the other end of the ribbon fiber cable 3. Attaching the cut end of the ribbon fiber cable 3 to the casing 5 adherent to the second equipment cabinet 2.

### TECHNICAL FIELD OF THE INVENTION

The present invention relates to methods and arrangements to minimize excess length of fiber cable between different equipment locations.

### DESCRIPTION OF RELATED ART

A challenge for large-scale point-to-point Fiber-To-The-Home installations is the large amount of fibers to terminate and route to active equipment in a central office. In a future scenario with all-fiber access, i.e. fiber replaces the current copper access, thousands of fibers or more could be terminated at one side. At these large sites, the optical distribution could be placed at one floor, while the active equipment could be placed at a different floor. This further emphasizes the importance of a flexible and cost effective fiber management solution in the central office. In a typical installation of today the outside plant fiber cable entering the central office must be terminated in a joint closure where it is fusion spliced to an indoor cable that terminates in a network side optical distribution frame ODF. The ODF is used as the interface. In the optical distribution frame ODF each fiber is accessible and in a transmission system designed for metro or backbone transport typically two ODFs (one for the network side and one for the equipment side) are used in order to obtain a full flexibility for equipment to network reconfiguration. Finally a patch cable is used to connect the fiber to the active equipment. One solution for the patch cable frequently used today is a breakout cable, which basically consist of several pre-connectorized patch cables inside a common cable sheath. This common sheath is easily removed and thereby provides flexibility to access the individual patch cables at the same it eases handling. Excess fiber is handled at the ODF, at cable ladders or at active equipment. Winding the excess fiber on reels placed inside the cabinets or outside in a separate cabinet next to e.g. the ODF cabinet usually does it. This can be done due to the relatively low quantities of fiber in the transport network. Storage of excess fiber cables is a problem that is well known, see for example U.S. Pat. No. 5,708,751. However, in a full scale FTTH access network the huge amount of fibers will need an improved way of handling excess fiber.

### SUMMARY OF THE INVENTION

The present invention solves problems related to expensive logistics and handling to keep track on fixed length breakout cables and space needed for winding of excess fiber between equipment in different equipment locations, such as cabinets.

The problems are solved by the invention by a method to couple together one end of a ribbon fiber cable to a first equipment cabinet. Then route the ribbon fiber cable without excess length to a second cabinet and finally couple together the other end of the ribbon fiber cable to the second cabinet.

More in detail, the problems are solved by a method to minimize excess fiber cable in large-scale point-to-point fiber installations between equipment located in different equipment cabinets. Each cabinet comprises at least one fan-out casing. The casings are arranged to connect the ribbon fiber cables with equipment in the cabinets via fan-out fiber cables. The method comprises the following steps:
One end of the ribbon fiber cable is attached to a casing that is adherent to a first equipment cabinet.
The ribbon fiber cable is routed with a minimum excess length to a casing adherent to a second equipment cabinet.
The other end of the ribbon fiber cable is cut close to the casing adherent to a second equipment cabinet.
The cut end of the ribbon fiber cable is attached to the casing adherent to the second equipment cabinet.

An arrangement according to the invention comprises means for performing the above mentioned method steps.

A purpose with the invention is to eliminate fiber excess length when connecting equipment in separate equipment cabinets.

Yet another advantage is that the cost of logistics and handling of different pre-connectorized cables are eliminated.

The invention will now be described more in detail with the aid of preferred embodiments in connection with the enclosed drawings.

### BRIEF DESCRIPTION OF THE DRAWINGS

FIG. 1 shows a block schematic illustration of a ribbon fiber cable and fan-out cables attaching equipment in two equipment cabinets.

FIG. 2 shows a fan-out casing which is used when fiber cables are spliced together.

FIG. 3 shows in a flow-chart some essential steps of the invention.

### DETAILED DESCRIPTION OF EMBODIMENTS

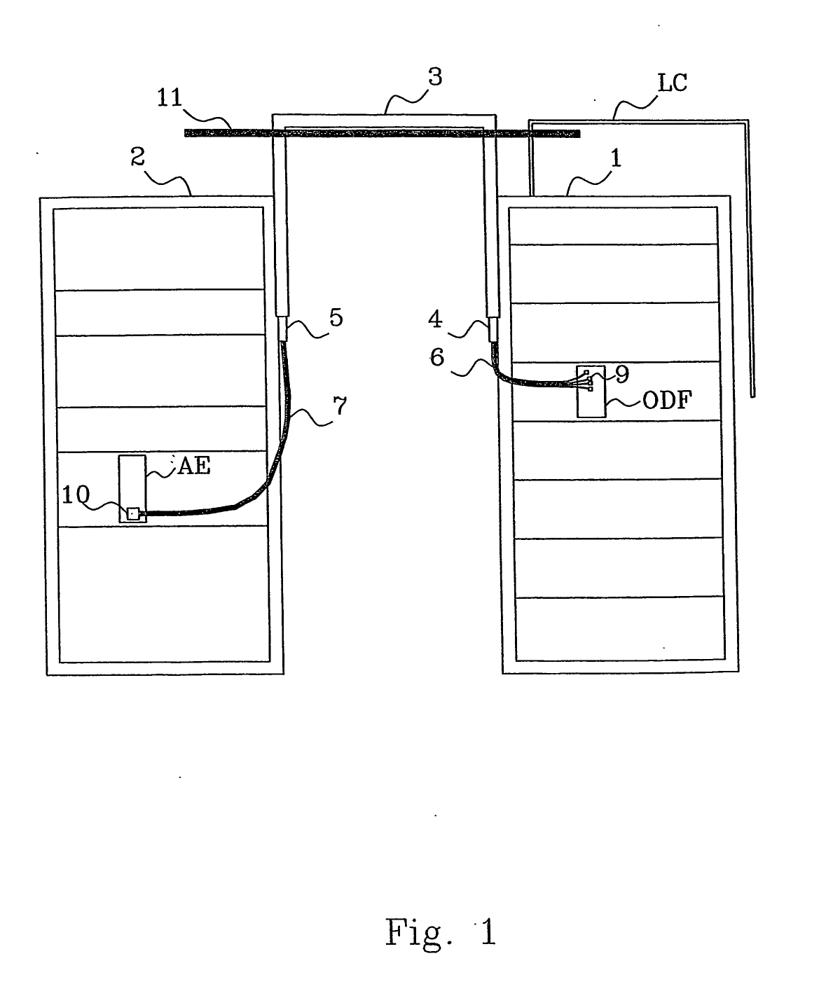

FIG. 1 discloses two equipment cabinets, a first cabinet 1 and a second cabinet 2. The first cabinet 1 is in this example an optical distribution frame ODF cabinet and comprises passive equipment like ODFs having individual MU connectors 9. The second cabinet 2 is an active equipment cabinet with eight channel array transmitters. Two fibers per subscriber is used, one for up link and one for down link. The ODF is used as an interface between the optical fiber cable system represented by a line cable LC in FIG. 1, and active equipment AE in the second cabinet 2.

For a system similar to the one disclosed in the schematic FIG. 1, 480 ribbon cables with 8 fibers each are necessary to connect the active equipment cabinet with the ODF cabinet. On the ODF side an 8-f ribbon fan-out cable 6 to single MU fan-out casing 4 is used. The fan-out casing 4 can be handled as part of the cable and hangs inside the cabinet, sufficiently close to an ODF panel for the MU connectors to reach it. In the example disclosed in FIG. 1 however, the fan-out casing is placed in a snap-in holder on the inside of the ODF cabinet side-wall (as an alternative, it could be placed on the outside). 480 fan-out casings must be handled per 1920 subscriber cabinet. The fan-out casing 4 is arranged to connect the ribbon fiber cable 3 with the fan-out cable 6.

On the active equipment cabinet side a ribbon splice casing 5 is used to connect an MPO-8 connector 10 (with an 8-f ribbon) to the 8-f ribbon in the ribbon fiber cable 3 coming from the ODF cabinet. The casing 5 for the 8-f ribbon splice is assumed to be approximately the same size as the fan-out casing 4 and with similar properties, and thus to be handled in the same way.

The method according to the invention will now be explained. The method comprises the following steps:
One end of a ribbon fiber cable 3 is spliced to the fan-out fiber cable 6 via the fan-out casing 4. The fan-out casing is placed in a snap-in holder on the inside of the cabinet 1.
The fan-out fiber cable 6 is attached, with a minimum of fan-out fiber cable excess length, to the optical distribution frame ODF in cabinet 1 via MU connectors 9.
The ribbon fiber cable 3 is routed from cabinet 1 on a cable ladder system 11 with a minimum of excess to cabinet 2.
The other end, i.e. the lose end, of the ribbon fiber cable is cut to a suitable length without cable excess length between the two cabinets 1 and 2.
The other end of a ribbon fiber cable 3 is spliced to a fan-out fiber cable 7 via the fan-out casing 5. The fan-out casing is placed in a snap-in holder on the inside of the cabinet 2.
The fan-out fiber cable 7 is attached, with a minimum of fan-out fiber cable excess length, to the active equipment AE in cabinet 2 via a MPO-8 connector 10.

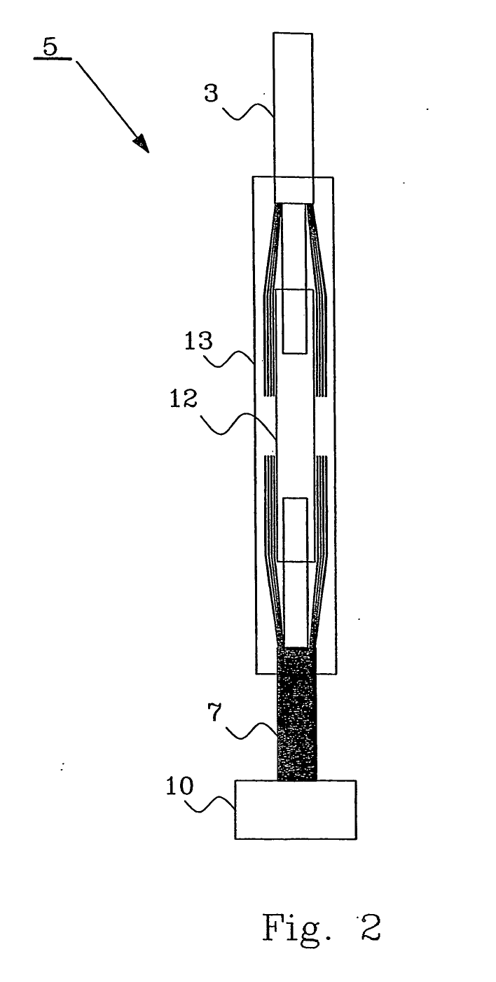

FIG. 2 discloses the fan-out casing 5 more in detail. The figure shows the fan-out cable 7 and the ribbon fiber cable 3 spliced together. The fan-out cable 7 is pre-connectorized with a MPO-8 connector 10. After estimation of suitable length of the ribbon fiber cable 3, without using excess length when routing the cable, the two cables 3 and 6 are spliced together on a splicing sleeve 12. A shrinking tubing 13 is attached over the splicing sleeve 12 and the spliced fibers 3 and 6, as protection.

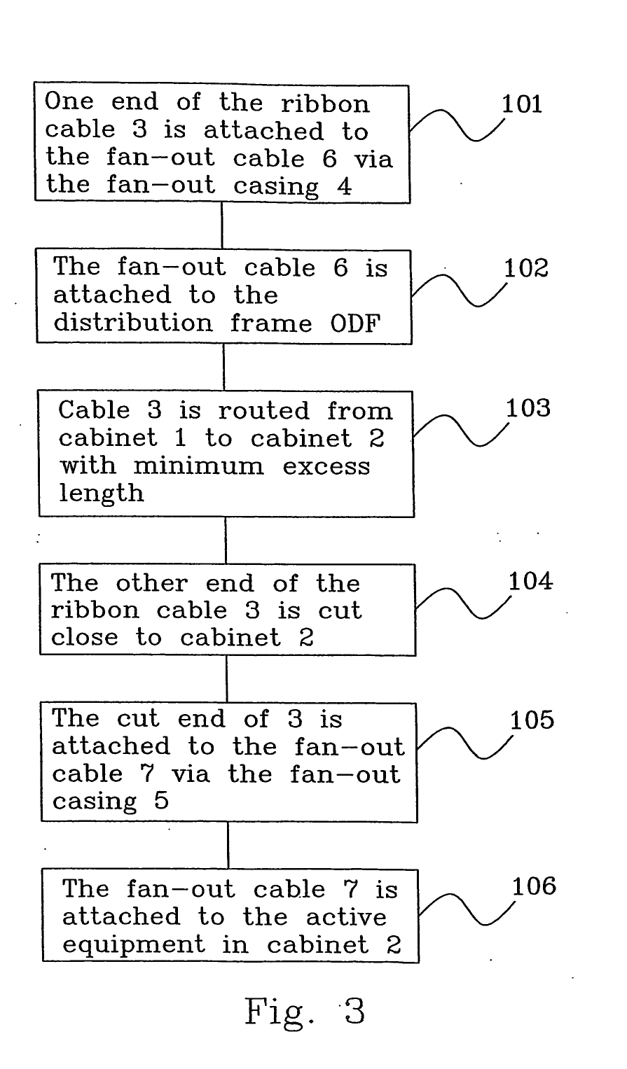

FIG. 3 shows some of the most essential steps of the method in a flow chart. The flow chart is to be read together with the earlier discussed FIGS. 1 and 2. The most essential steps of the method are as follows:
One end of the ribbon fiber cable 3 is attached to the fan-out fiber cable 6 via the fan-out casing 4. This is shown in FIG. 3 by a block 101.
The fan-out fiber cable 6 is attached to the optical distribution frame ODF in cabinet 1 via MU connectors 9. This is shown in FIG. 3 by a block 102.
The ribbon fiber cable 3 is routed from cabinet 1 on the cable ladder system 11 with a minimum of excess length to cabinet 2. This is shown in FIG. 3 by a block 103.
The other end of the ribbon fiber cable 3 is cut to a suitable length without cable excess length between the two cabinets 1 and 2. This is shown in FIG. 3 by a block 104.
The other end of a ribbon fiber cable 3 is attached to the fan-out fiber cable 7 via the fan-out casing 5. This is shown in FIG. 3 by a block 105.
The fan-out fiber cable 7 is attached to the active equipment AE in cabinet 2 via an MPO-8 connector 10. This is shown in FIG. 3 by a block 106.

The arrangement used in the invention comprises means for adjusting the cables to suitable length without excess. As means for adjusting the cables, a fiber and cable cutter might be used. As means for assembling a connector, a fiber cleaving tool, fiber polisher, assembly tool for connectors might be used. The fusion splicing is preferably done with a portable fusion splice means.

As mentioned, the reciprocal order between the method steps is of minor importance for the invention. The equipment locations can be located on different floors and routing of the ribbon fiber cable does not necessarily be on a cable ladder system. The splicing of cable ends does not necessarily have to be in a casing like the one disclosed in FIG. 2. The invention is of course not limited to the above described and in the drawings shown embodiments but can be modified within the scope of the enclosed claims.

1. Method to minimize excess fiber cable in large-scale point-to-point fiber installations, between a first and second equipment in different cabinets comprising at least one casing arranged to connect fiber cables between the first and second equipment in the cabinets via fan-out fiber cables, the method comprising the following steps:
attaching optical fibers from a first end of a ribbon fiber cable to fibers in a first fan-out fiber cable via a first casing that is adherent to a first cabinet;
routing the ribbon fiber cable with a minimum excess length to a second casing adherent to a second cabinet;
cutting the second end of the ribbon fiber cable; and
splicing the cut end of the ribbon fiber cable to a second fan-out fiber cable via the second casing adherent to the second cabinet.

2. Method to minimize excess fiber cable in large-scale point-to-point fiber installations according to claim 1 whereby each end of the ribbon fiber cable is spliced to a respective fan-out fiber cable by aid of fusion splicing.

3. Method to minimize excess fiber cable in large-scale point-to-point fiber installations according to claim 1 whereby the first and second fan-out fiber cables are routed between the first and second casings and first and second equipment respectively without excess length.

4. Method to minimize excess fiber cable in large-scale point-to-point fiber installations according to claim 1 whereby fibers in the fiber cables are spliced together over a splicing sleeve.

5. Method to minimize excess fiber cable in large-scale point-to-point fiber installations according to claim 1 whereby a shrinking tubing is attached over the splicing sleeve, as protection.

6. Arrangement to minimize excess fiber cable in large-scale point-to-point fiber installations between a first and a second equipment located in a first and second equipment cabinet respectively, each equipment cabinet comprising at least one casing, which casings are arranged to connect fiber cables with equipment in the locations via fan-out fiber cables, the arrangement comprising:
means for attaching the fibers in a first end of a ribbon fiber cable to the fibers in a first fan-out fiber cable via a first casing that is adherent to the first equipment cabinet;
means for routing the ribbon fiber cable with a minimum excess length to a second casing adherent to a second equipment cabinet;
means for cutting the other end of the ribbon fiber cable;
means for splicing the cut end of the ribbon fiber cable to a second fan-out fiber cable via the second casing adherent to the second equipment cabinet.
